(19) United States
(12) Patent Application Publication
(10) Pub. No.: US 2013/0085198 A1
(43) Pub. Date: Apr. 4, 2013

(54) AQUEOUS GEL COMPOSITION CONTAINING BUBBLES

(71) Applicant: User Co., Ltd., Osaka (JP)

(72) Inventors: Masaru ISHIGAKI, Osaka (JP); Nobuyoshi TANAKA, Osaka (JP)

(73) Assignee: USER CO., LTD., Osaka (JP)

(21) Appl. No.: 13/632,423

(22) Filed: Oct. 1, 2012

(30) Foreign Application Priority Data
Oct. 3, 2011 (JP) 2011-218994

(51) Int. Cl. C08L 33/02; C08L 29/04

(52) U.S. Cl. 521/149

(57) ABSTRACT

To present an aqueous gel composition containing bubbles light in weight, soil and elastic, and continuous in cool feel or warm feel.

An aqueous gel composition containing bubbles containing a bubbling gas in a mixture of a solvent mainly composed of water, in which a polymer and a crosslinking agent are dissolved.

### TECHNICAL FIELD

The present invention relates to an aqueous gel composition containing bubbles, more particularly to an aqueous gel composition containing bubbles light in weight, soft and elastic, and continuous in cool feel or warm feel.

### BACKGROUND ART

Conventionally, aqueous gel compositions have, been used widely for cooling fresh foods or giving a cool sense to the human body.

However, the conventional aqueous gel compositions are mainly composed of water, and the weight is heavy, for example, when applied in bedding.

On the other hand, to overcome this demerit, when the content of the aqueous gel composition is decreased, the durability of cold sense or warm sense is lost, and there is a trade-off relation, and both functions cannot be satisfied.

On the other hand, foams such as urethane foams applied in bed, pillow, cushion, an bedding are light in weight and soft in touch, and excellent in warmth keeping property, but lack in cold sense.

### SUMMARY OF THE INVENTION

### Problems to Be Solved by the Invention

It is hence an object of the invention to present an aqueous gel composition containing bubbles, light in weight, soft in touch, and durable in cold sense and warm sense, not obtainable in conventional aqueous gel compositions or foams.

### Means for Solving the Problems

To achieve, the object, the aqueous gel composition containing bubbles is characterized by containing a bubbling gas in a mixture of a solvent mainly composed of water, in which a polymer and a crosslinking agent are dissolved,

In this case, the polymer is at least one kind of polymer selected from polyacrylic acid, polyvinyl alcohol, and their denatured compounds.

The polymer is dissolved by 1 to 40 parts by mass in 100 parts by mass of the solvent.

The content of bubbles in the dissolved mixture of the solvent, polymer and crosslinking agent is 0.2 to 5 times (ratio by volume).

The surface hardness measured by durometer hardness meter F type is 50 or less.

A latent heat reserve material may be contained.

### Effects of the Invention

According to the aqueous gel solution containing bubbles of the present invention, we can obtain an aqueous gel composition containing bubbles, light in weight, soft in touch, and durable in cold sense and warm sense, not obtainable in conventional aqueous gel compositions or foams.

In particular, when a latent heat reserve material is contained, the durability of cold sense and warm sense can be further enhanced.

### BRIEF DESCRIPTION OF THE DRAWINGS

FIG. 1 is a graph showing temperature characteristics of aqueous gel composition containing bubbles and the same composition further containing a latent heat reserve material.

FIG. 2 is an explanatory diagram showing an application example of the aqueous gel composition containing bubbles of the invention.

### EMBODIMENT OF THE INVENTION

An embodiment of an aqueous gel solution containing bubbles of the invention is described below.

The aqueous gel solution containing bubbles of the invention is characterized by containing a bubbling gas in a mixture of a solvent mainly composed of water, in which a polymer and a crosslinking agent are dissolved.

In this case, the solvent mainly composed of water mainly contains water, and may also contains other additives in order to lower the freezing point, such as alcohol, ethylene glycol, glycerin and other organic matter, or salt, sodium sulfate and other inorganic matter.

To prevent putrefaction of the aqueous gel composition, any commercial preservatives ma be added.

To decorate the aqueous gel composition, coloring matter or pigment may be added.

To prevent discoloration of the aqueous gel composition, antioxidant, ultraviolet absorber, or similar materials may be added.

The polymer may be at least one kind of polymer selected from sodium polyacrylate, polyvinyl alcohol, and their denatured compounds.

Examples of polyacrylic acid and its denatured compound are not particularly specified as far as they are dissolved in water, including acids alone, partially neutralized with caustic soda, caustic potash, amine or the like, or copolymers, with other acryl, methacrylic acid derivatives and others.

Examples of polyvinyl alcohol and its denatured compound are selected freely at an arbitrary degree of polymerization or saponification, and may include aceto-acetylic, anionic, or cationic denatured compounds.

If necessary, other polymers may be added.

Examples of other polymers may include polyglycolic acid, dextrin, alginic acid, polyamino acid, chitosan, and polyacrylic acid copolymer.

These polymers are crosslinked three-dimensionally by a crosslinking agent.

Usable examples of the crosslinking agent include any compounds reacting with these polymers, such as methylol melamine derivative, hydrophilic epoxy resin, water dispersive polyisocyanate, boric arid, alkoxy titanium derivative, and alkoxy aluminum derivative.

Further, to promote the reaction between the polymer and the crosslinking agent, amine, peroxide, or other catalysts may be added.

The polymer is dissolved by 1 to 40 parts by mass in 100 parts by mass of the solvent.

If the content of the polymer is less than I part by mass in 100 parts by mass of the solvent, the viscosity is low, and it is hard to maintain the state of containing bubbles in the mixture.

If the content of the polymer is more than 40 parts by mass in 100 parts by mass of the solvent, the hardness is high, and it is hard to obtain a soft elasticity,

The content of bubbles in the dissolved mixture of the solvent, polymer and crosslinking agent is 0.2 to 5 times (ratio by volume).

If the content of bubbles is less than 0.2 times (ratio by volume), the weight reducing effect is small, and it is hard to obtain a soft elasticity.

If the content of bubbles is more than 5 times (ratio by volume), the bubbles are large, and it is hard to obtain a soft elasticity, and it is also hard to maintain the state of containing bubbles in the mixture.

The surface hardness of the aqueous gel composition containing bubbles as measured by durometer hardness meter F type is 50 or less.

As a result, a soft elasticity can be obtained.

A latent heat reserve material may be contained in the aqueous gel composition.

As a result, the durability of cold sense and warm sense can be further enhanced.

Preferred examples of the latent heat reserve material include normal paraffin of melting point of 20 to 35° C., and emulsion of alpha-olefin.

More specifically, the normal paraffin and alpha olefin have an intrinsic melting point and fusion calorie of each substance, but by mixing these components, the melting point can be selected. The fusion calorie is about. 200 kj/kg, as compared with about 330 kj/kg of water.

Since the normal paraffin and alpha-olefin are. hydrophobic, they are emulsified, and may be added to an aqueous solution of polyacrylic acid or polyvinyl alcohol.

Preferably, the latent heat reserve material is added by 10 to 25 wt. % in the aqueous gel composition.

If the content of the latent heat reserve material is less than 10 wt. %, it is hard to obtain its effect.

If the content of the latent heat reserve material is more than 25 wt. %, it is hard to obtain a soft elasticity.

As the method of containing a bubbling gas in the dissolved mixture of the solvent mainly composed of water, and the polymer and crosslinking agent, for example, an arbitrary gas such as air, nitrogen gas, or carbon dioxide is added in the mixture while stirring, or the mixture is stirred and gelated in an arbitrary gas atmosphere such as air, nitrogen gas, or carbon dioxide so as to take in the gas, so that the bubbles may be stably formed in the mixture.

Further, in the solvent mainly composed of water and the polymer, a bubbling gas is contained by the method mentioned above, and the crosslinking agent is added to be gelated, and thereby bubbles may he stably formed in the mixture.

In addition, in order to obtain an aqueous gel composition containing bubbles stably, a foam controlling agent or a defoaming agent may be added, or in order to promote generation of foams, anionic, or nonionic, or other surface active agent may be added.

As other method of containing a bubbling gas in the dissolved mixture of the solvent mainly composed of water, and the polymer and crosslinking agent, still more, a chemical foaming method by using a foaming agent is known, and for example, azo-bis isobutyronitrile or other azo compound, sodium hydrogencarbonate, other carbonate, and polyacrylic acid, citric acid, or other organic carboxylic acid may be combined, so that bubbles may be contained in the mixture.

The aqueous gel composition containing bubbles has excellent properties such as light weight, soft elasticity and duration of cold sense and warm sense, that could not be obtained in the conventional aqueous gel compositions or foams because of the trade-off relation, and hence it is preferably used in bed, pillow, cushion, or other bedding applications,

### Exemplary Embodiments

Referring to the exemplary embodiments, the aqueous gel composition containing bubbles of the present invention is specifically described below, but it must be noted that the invention is not limited to the illustrated embodiments alone.

### [Measuring Method]

### Surface Hardness

By using durometer hardness meter F type manufactured by Kobunshi Keiki Co., the surface hardness was measured by obtaining a support value when placed on a sample of aqueous gel composition containing bubbles of 10 mm or more in thickness. It was measured at three different positions, and the average was obtained.

### Durability of Cold Sense (Warm Sense)

In a polyethylene bas measuring 10×15 cm kept at 25° C., a gel composition filled with 100 g of sample was put on a hot plate of 40° C., and the time until the upside temperature exceeds :35° C. was measured.

### EXAMPLE 1

By mixing 100 parts by mass of polyacrylic acid (RD-148 manufactured by GOO Chemical) aqueous solution (25 parts by mass of polyacrylic acid, 75 parts by mass of water), 2 parts by mass of epoxy crosslinking agent (RD-144manufactured by GOO Chemical), 1 part by mass of thickener (Carbopol ETD-2020 manufactured by Hitachi Chemicals), and 1 part by mass of taming agent (Amizole FD manufactured by Kawaken Fine Chemicals), the mixture was stirred and foamed by a food mixer, and poured into a container, and an aqueous gel composition containing bubbles by 3 times (ratio by volume) was obtained.

### COMPARATIVE EXAMPLE 1

The same composition as in Example 1 was gelated without being foamed.

### EXAMPLE 2

By mixing 100 parts by mass of aceto-acetylic polyvinyl alcohol (Z-320 manufactured by Nihon Gosei Kagaku Co., degree of saponification about 92%, viscosity about 20 mPa·s) 10% aqueous solution, and 5 parts by mass of water-dispersive polyisocyanate (Takenate WD-725 manufactured by Mitsui Chemical), same as in Example 1, and an aqueous gel composition containing bubbles by 2 times (ratio by volume) was obtained.

### COMPARATIVE EXAMPLE 2

The same composition as in Example 2 was gelated without being foamed,

### EXAMPLE 3

Instead of the aceto-acetylic polyvinyl alcohol used in Example 2, partially saponified polyvinyl alcohol (GH-17 manufactured by Nihon Gosei Kagaku Co., degree of saponification about 88%, viscosity about 30 mPa·S) was used, together with a crosslinking agent, titanium lactate (Orgatics TC-310 manufactured by Matsumoto Fine Chemical), and an aqueous act solution was obtained by keeping at 90° C.

### EXAMPLE 4

In 45 parts by mass of normal paraffin heated to 45° C. (TS-8 manufactured by JX Holdings Co, a solution of 51 parts by mass of water heated to 45° C. 3 parts by mass of polyvinyl alcohol (GH-17 manufactured by Nihon Gosei Kagaku Co.), and I part by mass of BYK dispersion agent (manufactured by BYK) was added while agitating violently. Alter addition, the solution was cooled to 25° C. during agitation, and a normal paraffin emulsion was manufactured.

In a mixture of 40 parts by mass of the manufactured normal paraffin emulsion, and 60 parts by mass of 10% aceto-acetylic polyvinyl alcohol used in Example 2, 5 parts by mass of water-dispersive polyisocyanate was added, and in the same mariner as in Example 1, an aqueous gel composition containing bubbles by 2 times (ratio by volume) was obtained.

Table 1 shows results of measurement of surface hardness and duration of cold sense of Examples 1 to 4 and Comparative examples 1 and 2.

TABLE 1

| | | Comparative | |
|---|---|---|---|
| | Example 1 | example 1 | Example 2 |
| Surface hardness | 36 | 78 | 28 |
| Duration of cold | 120 | 35 | 100 |
| sense (minutes) | | | |

| | Comparative | | |
|---|---|---|---|
| | example 2 | Example 3 | Example 4 |
| Surface hardness | 57 | 25 | 16 |
| Duration of cold | 40 | 90 | 240 |
| sense (minutes) | | | |

As clear from Table 1, the aqueous gel compositions containing bubbles of Examples 1 to 4 are, as compared with the aqueous gel compositions of Comparative examples 1 and 2, smaller in surface hardness, and longer in duration of cold sense.

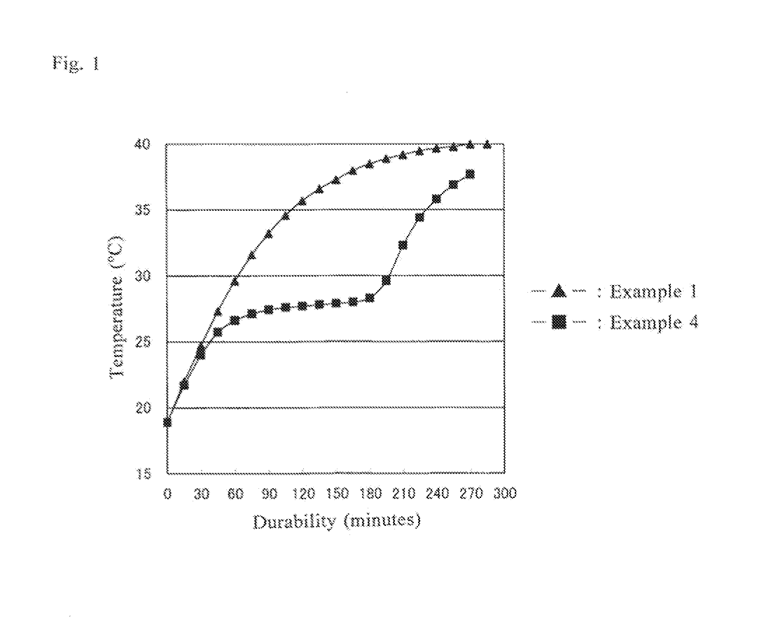

FIG. 1 shows the temperature characteristics of the aqueous gel composition containing bubbles (Example 2) and the composition further containing a latent heat reserve material (Example 4).

As clear from FIG. 1, by containing a latent heat reserve material, it is confirmed that the duration of cold sense (warm sense) is further enhanced.

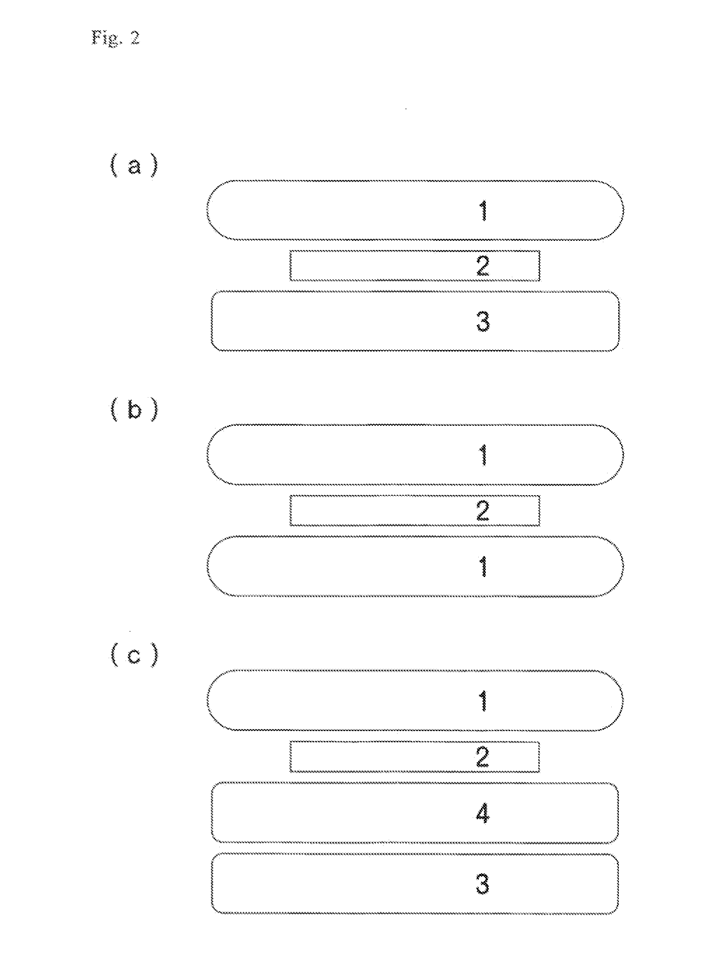

FIG. 2 shows application examples of the aqueous gel composition containing bubbles of the invention.

The aqueous gel composition containing bubbles of the invention is contained in a packaging material made of synthetic resin sheet, and is preferably applied as bed, pillow, cushion, or other bedding, and further as foot warmer, and other cooling and warming tools.

More specifically, as shown in FIG. 2(a), for example, the aqueous gel composition containing bubble is inserted into a packaging material made of synthetic resin sheet to be used as an insertion element, or is used as cold and heat insulator 2 as cold preservative or bed warmer, or used in a lamination of insulating materials 3 of foamed polyethylene, or as shown in FIG. 2(b), the insertion element 1, the cold and heat insulator 2, the insertion element 1, and the insulating material 3 may be sequentially laminated, or as shown in FIG. 2(c), the insertion element 1, the cold and heat insulator 2, a ventilation material 4 such as raschei lace, and the insulating material 3 may be sequentially laminated and used.

Hence, it is possible to keep cool or warm moderately for a long time.

The aqueous gel composition containing bubbles of the invention is described herein, but the invention is not limited to such illustrated examples alone, but may be freely changed or modified within the scope not departing from the true spirit thereof.

### INDUSTRIAL APPLICABILITY

The aqueous gel composition containing bubbles of the invention has excellent properties such as light weight, soft elasticity and duration of cold sense and. warm sense, that could not be obtained in the conventional aqueous gel compositions or fbams because of the trade-off relation, and hence it is preferably used in bed, pillow, cushion, or other bedding applications.

1. An aqueous gel composition containing bubbles containing a bubbling gas in a mixture of a solvent mainly composed of water, in which a polymer and a crosslinking agent are dissolved.

2. The aqueous gel composition containing bubbles according to claim 1, wherein the polymer is at least one kind of polymer selected from polyacrylic acid, polyvinyl alcohol, and their denatured compounds.

3. The aqueous gel composition containing bubbles according to claim 1, wherein the polymer is dissolved by 1 to 40 parts by mass in 100 parts by mass of the solvent.

4. The aqueous gel composition containing bubbles according to claim 1, wherein the content of bubbles in the dissolved mixture of the solvent, polymer and crosslinking agent is 0.2 to 5 times (ratio by volume).

5. The aqueous gel composition containing bubbles according to claim 1, wherein the surface hardness measured by durometer hardness meter F type is 50 or less.

6. The aqueous gel composition containing bubbles according to claim 1, further containing a latent heat reserve material.

7. The aqueous gel composition containing bubbles according to claim 2, wherein the polymer is dissolved by 1 to 40 parts by mass in 100 parts by mass of the solvent.

8. The aqueous gel composition containing bubbles according to claim 2, wherein the content of bubbles in the dissolved mixture of the solvent, polymer and crosslinking agent is 0.2 to 5 times (ratio by volume).

9. The aqueous gel composition containing bubbles according to claim 3, wherein the content of bubbles in the dissolved mixture of the solvent, polymer and crosslinking agent is 0.2 to 5 times (ratio by volume).

10. The aqueous gel composition containing bubbles according to claim 7, wherein the content of bubbles in the dissolved mixture of the solvent, polymer and crosslinking agent is 0.2 to 5 times (ratio by volume).

11. The aqueous gel composition containing bubbles according to claim 2, wherein the surface hardness measured by durometer hardness meter F type is 50 or less.

12. The aqueous gel composition containing bubbles according to claim 3, wherein the surface hardness measured by durometer hardness meter F type is 50 or less.

13. The aqueous gel composition containing bubbles according to claim 4, wherein the surface hardness measured by durometer hardness meter F type is 50 or less.

14. The aqueous gel composition containing bubbles according to claim 7, wherein the surface hardness measured by durometer hardness meter F type is 50 or less.

15. The aqueous gel composition containing bubbles according to claim 8, wherein the surface hardness measured by durometer hardness meter F type is 50 or less.

16. The aqueous gel composition containing bubbles according to claim 9, wherein the surface hardness measured by durometer hardness meter F type is 50 or less.

17. The aqueous gel composition containing bubbles according to claim 10, wherein the surface hardness measured by durometer hardness meter F type is 50 or less.

18. The aqueous gel composition containing bubbles according to claim 2, further containing a latent heat reserve material.

19. The aqueous gel composition containing bubbles according to claim 3, further containing a latent heat reserve material.

20. The aqueous gel composition containing bubbles according to claim 7, further containing a latent heat reserve material.
